(19) United States
(12) Patent Application Publication
(10) Pub. No.: US 2010/0061110 A1
(43) Pub. Date: Mar. 11, 2010

(54) LIGHTING SYSTEM WITH A FLAT LAMP AND A FRAME

(75) Inventors: Juergen Beck, Heuchlingen (DE); Bert Schlenga, Giengen (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/526,952

(22) PCT Filed: Jan. 28, 2008
(86) PCT No.: PCT/EP08/50944

§ 371 Date: Aug. 13, 2009

(30) Foreign Application Priority Data
Feb. 13, 2007 (DE) 20 2007 002 131.3

(51) Int. Cl. F21V 19/00

(52) U.S. Cl. 362/382

(57) ABSTRACT

A lighting system has a flat lamp, which has a front side intended for light emission and a rear side opposite thereto, a frame, which encloses at least the edge of the flat lamp, wherein the frame includes a top part and a bottom part, the frame top part and the frame bottom part being connected to one another using a releasable connector, and the flat lamp being situated between the frame top part and the frame bottom part, oriented such that the front side of the flat lamp faces toward the frame top part.

### TECHNICAL FIELD

The invention is directed to a lighting system having a frame and a flat lamp situated therein.

Lighting systems of this type are used for manifold lighting tasks, in particular also for lights in general lighting and for the backlighting of liquid crystal displays (LCD)—also referred to there as backlight units (BLU). Large-format LCD televisions may be cited in particular as an application for backlighting tasks that has increasingly gained attention in recent times.

The term “flat lamp” refers here to lamps, in particular fluorescent lamps, having a planar geometry, which emit white or colored light, and also UV light for special applications.

The planar geometry does not preclude, for example, the front side of the flat lamp, which is intended for the light emission, having a structure, e.g., corrugated or ribbed. The lamp vessel of the flat lamp thus does not necessarily have to be formed from planar glass plates.

In addition to conventional flat lamps having a mercury and/or noble gas filling, the invention is also directed in particular to flat lamps of the dielectric barrier discharge type. In this lamp type, either the electrodes of one polarity or all the electrodes, i.e., the electrodes of both polarities, are separated from the discharge using a dielectric layer (single-sided or double-sided dielectric barrier discharge). Electrodes of this type are also referred to hereafter for short as “dielectric electrodes”. Furthermore, it should also be clarified that the dielectric layer does not have to be a layer applied especially for this purpose to an electrode, but rather may also be formed by a discharge vessel wall, for example, specifically if the typically strip-shaped and/or linear electrodes are situated on the outer side of a discharge vessel wall or inside the wall.

Flat lamps of the dielectric barrier discharge type have proven to be particularly efficient flat light sources if they are operated using the pulsed operating method described in U.S. Pat. No. 5,604,410, and are therefore especially well suited for use in a light and/or a backlight unit.

### PRIOR ART

Document EP 1 600 808 A1 discloses a lighting system having a flat lamp. There, the flat lamp is inserted into a housing having a rear wall and a peripheral side wall. A frame which is put onto the side wall and is also peripheral fixes the flat lamp inside the housing.

### SUMMARY OF THE INVENTION

The object of the present invention is to provide a further lighting system having a flat lamp, in which the flat lamp can be replaced simply and is nonetheless reliably mechanically protected.

This object is achieved by a lighting system having a flat lamp which has a front side intended for light emission and a rear side opposite thereto, a frame which encloses at least the edge of the flat lamp, characterized in that the frame comprises a top part and a bottom part, the frame top part and the frame bottom part being connected to one another using a releasable connector and the flat lamp being situated between the frame top part and the frame bottom part, oriented such that the front side of the flat lamp faces toward the frame top part.

Particularly advantageous designs are found in the dependent claims.

The frame of the lighting system according to the invention thus has a bottom part and a top part, the two frame parts being removably connected to one another, for example, by a catch mechanism. On the one hand, this ensures a secure connection between frame top part and frame bottom part and thus reliably prevents the lamp from falling out. On the other hand, it also allows simple replacement of the lamp.

The frame bottom part is preferably provided at least sectionally with a catch lug on its peripheral edge. The peripheral edge of the frame top part is formed such that it encompasses the peripheral edge of the frame bottom part. The frame top part has an associated depression, in which the catch lug of the frame bottom part may engage. Alternatively, other releasable catch mechanisms are also suitable, for example in that the frame top part has pins which engage in associated openings in the frame bottom part.

In addition, it is also conceivable in principle to connect the two frame parts using external clamps or similar means. The clamps may also be integrated in a housing, for example a light housing, for this purpose. In this case, the two frame parts are inserted with the flat lamp into the open housing. After the housing is closed, the two frame parts are connected to one another and finally the flat lamp enclosed therein is also fixed.

During the assembly, the flat lamp is simply inserted into the frame bottom part. The frame bottom part preferably has suitable guides for positioning the lamp. The frame top part is then put on and preferably thereby engaged with the frame bottom part.

For the further support and stabilization of the flat lamp, it may be advantageous to additionally provide the frame bottom part with a rear wall adjacent to the rear side of the flat lamp, in particular in the case of very large-area and relatively thin flat lamps, with which the danger of breaking is of course especially great because of their filigree exterior. The rear wall may be inserted into the frame bottom part or integrated therewith to form a one-piece unit. In order to save weight, it is at least preferable to provide the rear wall with openings, without the stability suffering significantly. In certain circumstances, it may also suffice to form the rear wall as a supporting cross. The frame according to the invention thus combines the advantage of mechanical simplicity and a low number of required individual parts—in the simplest case only two, namely the frame top part and the frame bottom part—with reliable mechanical protection of the flat lamp and simple installation and/or replacement thereof. In addition, electrical protection is also provided by maintaining the required air gaps and creep distances, for example in lights according to the standards UL 1598 and EN 60598-1. Air gaps and creep distances of at least 12.7 mm are required here. Taking additional safety into consideration, the design according to the invention also allows larger distances, e.g. 15 mm to the electrode tracks of a dielectric barrier flat lamp having external electrodes. In addition, the frame preferably comprises a material which is extensively resistant to aging and UV, outgases as little as possible, has a dielectric strength of as many kilovolts as possible, in particular greater than 6 kV, and a temperature resistance up to approximately 120° C. In particular, the following multicomponent plastics have proven to be suitable:

polyethylene (PE)/polypropylene (PP),
polymethyl methacrylate (PMMA)/polystyrene (PS),
cellulose acetate (CA)/acrylonitrile-butadiene-styrene copolymer (ABS) and
polycarbonate (PC)/ABS.

In an advantageous refinement, the frame bottom part has a cable outlet, through which the electrical connection cable of the flat lamp is led. A strain relief for the connection cable is preferably integrated in the cable outlet.

### BRIEF DESCRIPTION OF THE DRAWINGS

The invention is explained in greater detail hereafter on the basis of an exemplary embodiment. In the figures:

FIG. 1 shows a horizontal projection of an exemplary embodiment of the lighting system according to the invention,

FIG. 2a shows a horizontal projection of the top part of the frame from FIG. 1,

FIG. 2b shows a horizontal projection of the bottom part of the frame from FIG. 1,

FIG. 3 shows a partial sectional illustration of the lighting system from FIG. 1 along line AA,

FIG. 4 shows a partial sectional illustration of the lighting system from FIG. 1 along line BB.

### PREFERRED EMBODIMENT OF THE INVENTION

Identical or functionally identical elements are provided with identical reference numerals in the figures.

An exemplary embodiment of the lighting system 1 according to the invention is schematically shown in FIG. 1 in a horizontal projection from above, i.e. on the front side intended for light emission. The peripheral top part 2 of a frame 3 made of PE/PP can be seen. The frame 3 encloses the edges of a rectangular flat lamp 4, which is designed for operation using dielectric barrier discharges. The front side 5 of the flat lamp 4 is visible through the opening of the frame top part 2. One longitudinal side 6 of the four longitudinal sides of the frame 3 is widened, because the cable feed (not shown in this figure) is integrated therein.

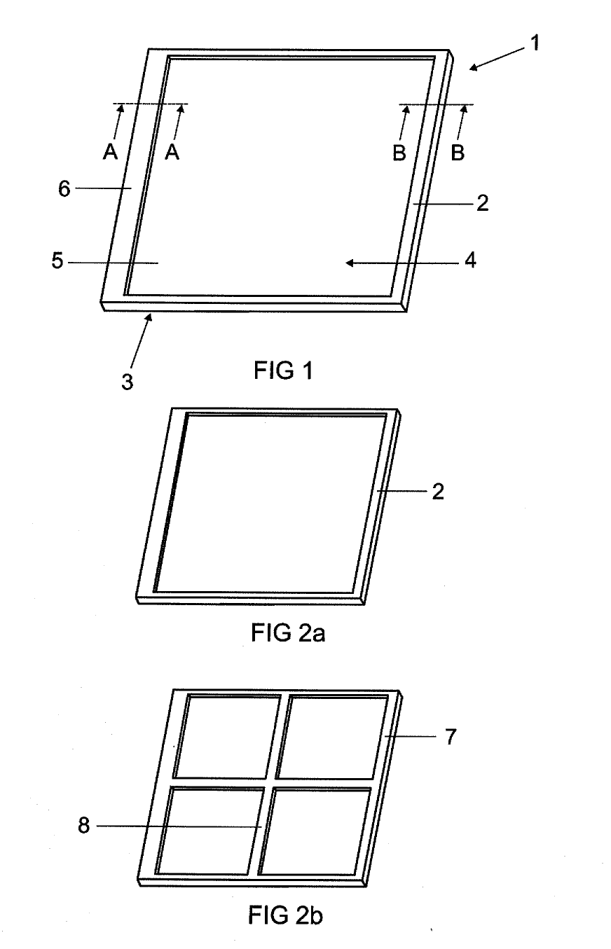

Reference is made hereafter to FIGS. 2a and 2b, which show the frame top part 2 and a frame bottom part 7 matching it, respectively, in the separated state. In FIG. 1, in contrast, the frame top part 2 and the frame bottom part 7 are fitted together, so that the flat lamp 4 is fixed such that it is clamped between them. The frame bottom part 7 has a supporting cross 8, which is used to support the flat lamp 4, whose rear side rests on the supporting cross 8.

In principle, a base plate incorporated in the frame bottom part also comes into consideration for the support. However, the supporting cross fulfills the same purpose, but advantageously at lower weight than a solid base plate.

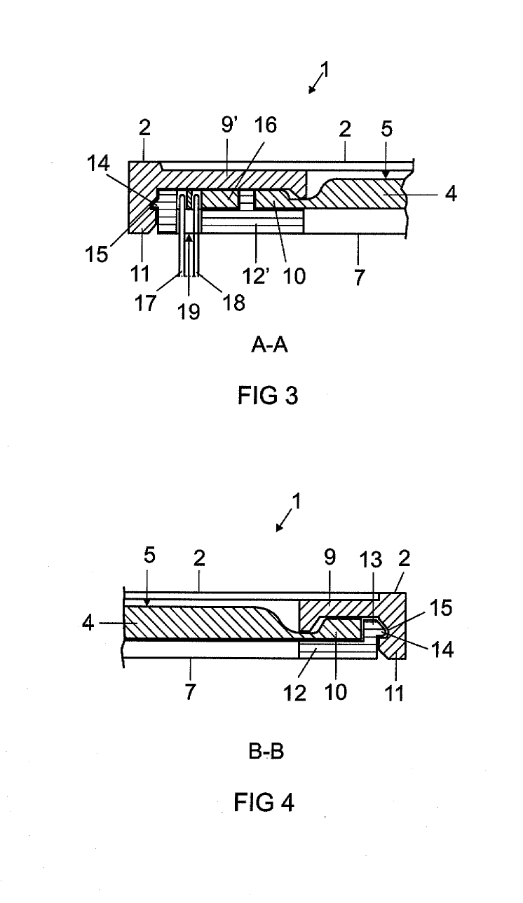

For further details, reference is made hereafter to FIGS. 3 and 4, which each show a partial sectional illustration along section lines AA and BB, respectively, in FIG. 1. The frame top part 1 has an essentially rectangular profile in the edge area. One leg 9 of the profile of the frame top part 2 extends parallel to the flat lamp 4 and overlaps its edge section 10 from above. The other leg 11 of the profile extends perpendicular thereto in such a way that it peripherally encompasses the frame bottom part 7 on its edge. The frame bottom part 7 also has a rectangular profile on the edge.

One leg 12 of the profile of the frame bottom part 7 extends parallel to the flat lamp 4 and supports its edge section 10 from below. The other leg 13 of the profile extends perpendicular thereto and thus prevents the flat lamp 4, which is placed on the frame bottom part 7, from slipping away laterally. The associated vertical legs 13 preferably each have a catch lug 14 pointing outward, i.e. away from the flat lamp 4, and extending at least along a partial area of the side, on two opposing sides of the frame bottom part 7. The catch lugs are each engaged with an associated depression 15 in the encompassing vertical leg 11 of the frame top part 2. In this way, the lighting system 1 may be assembled very simply, in that the flat lamp 4 is inserted into the frame bottom part 7 and subsequently the frame top part 2 is put thereon and engaged with the frame bottom part 7. In addition, the frame top part 2 can also be removed easily at any time, in order for example to replace the flat lamp 4. For this purpose, the engaged vertical legs 11 of the frame top part 2 are bent slightly outward, until the catch lugs 14 are free and the frame top part 2 can be removed unobstructed.

The legs 9′, 12′ of the frame top part 2 and frame bottom part 7, respectively, which extend parallel to the flat lamp 4, are wider along one of the four edges. Specifically, in addition to the corresponding edge section 10 of the flat lamp 4, a cable outlet 16 having integrated strain relief for the two electrical connection cables 17, 18 of the flat lamp 4 is inserted between these wider legs 9′, 12′. The connection cables 17, 18 are led with the aid of the cable outlet 16 through an opening 19 in the frame bottom part 7 to the rear, i.e. opposite to the light emission direction.

1. A lighting system, comprising:
a flat lamp, which has a front side intended for light emission and a rear side opposite thereto,
a frame, which encloses at least the edge of the flat lamp,
wherein the frame comprises a top part and a bottom part, the frame top part and the frame bottom part being connected to one another using a releasable connector, and the flat lamp being situated between the frame top part and the frame bottom part, oriented such that the front side of the flat lamp faces toward the frame top part.

2. The lighting system as claimed in claim 1, wherein the releasable connector is formed by a catch mechanism, by which the frame top part and the frame bottom part are engaged with one another.

3. The lighting system as claimed in claim 2, wherein the peripheral edge of the frame top part encompasses the peripheral edge of the frame bottom part and the frame bottom part at least sectionally has a catch lug on its peripheral edge, which lug engages with an associated depression on the frame top part.

4. The lighting system as claimed in claim 1, wherein the releasable connector is formed by at least one clamp, by which the frame top part and the frame bottom part are releasably connected to one another.

5. The lighting system as claimed in claim 1, wherein the frame bottom part has a rear wall provided with openings, whereby a supporting cross is formed, which supports the rear side of the flat lamp.

6. The lighting system as claimed in claim 1, wherein the frame further comprises a cable outlet, through which the electrical connection cable of the flat lamp is led.

7. The lighting system as claimed in claim 6, wherein the cable outlet comprises an integrated strain relief for the electrical connection cable.

8. The lighting system as claimed in claim 6, wherein the electrical connection cable is led outward through an opening in the frame bottom part.

9. The lighting system as claimed in claim 1, wherein the frame comprises plastic.

10. The lighting system as claimed in claim 1, wherein the flat lamp is designed for operation using dielectric barrier discharge.
